(19) United States
(12) Patent Application Publication
(10) Pub. No.: US 2025/0260964 A1
(43) Pub. Date: Aug. 14, 2025

(54) RELIABLE EMERGENCY SHORT MESSAGE SERVICE OVER INTERNET PROTOCOL (IP) MULTIMEDIA SUBSYSTEM (IMS)

(71) Applicant: QUALCOMM Incorporated, San Diego, CA (US)

(72) Inventors: Stephen William EDGE, Escondido, CA (US); Nishant GUPTA, Bangalore (IN)

(21) Appl. No.: 19/046,384

(22) Filed: Feb. 5, 2025

Related U.S. Application Data
(60) Provisional application No. 63/647,135, filed on May 14, 2024.
(60) Provisional application No. 63/552,636, filed on Feb. 12, 2024.

(51) Int. Cl. H04W 4/90; H04L 65/1016; H04L 65/1073; H04L 65/1104; H04W 4/14

(52) U.S. Cl. CPC H04W 4/90; H04L 65/1016; H04L 65/1073; H04L 65/1104; H04W 4/14

(57) ABSTRACT

Techniques are described for sending an emergency related Short Message Service message (SM) from a user equipment (UE) to a Public Safety Answering Point (PSAP) with higher reliability and security and lower delay than with previous techniques. Following detection of a user input emergency SM, a UE establishes a Session Initiation Protocol (SIP) dialogue with a PSAP, where the SIP dialogue has no active SIP media, which can be compliant with SIP protocol rules. The emergency SM is sent to the PSAP in association with the SIP dialogue, as are any subsequent SMs, and PSAP SM replies are similarly returned to the UE. Media such as voice may be added and previous restrictions on support of UEs that are roaming or in limited service state can be overcome.

### RELATED APPLICATIONS

This application claims the benefit of U.S. Provisional Application No. 63/552,636, filed Feb. 12, 2024, entitled “RELIABLE EMERGENCY SHORT MESSAGE SERVICE OVER INTERNET PROTOCOL (IP) MULTIMEDIA SUBSYSTEM (IMS),” and U.S. Provisional Application No. 63/647,135, filed May 14, 2024, entitled “RELIABLE EMERGENCY SHORT MESSAGE SERVICE OVER INTERNET PROTOCOL (IP) MULTIMEDIA SUBSYSTEM (IMS),” both of which are assigned to the assignee hereof and incorporated herein by reference in their entirety.

### BACKGROUND

A wireless cellular network may enable a user equipment (UE), such as a mobile phone, to contact a Public Safety Answering Point (PSAP) for emergency services by sending a Short Message Service (SMS) message to an emergency number (e.g., 911 or 112).

Previous solutions for transferring an SMS message (SM) from a mobile device to a PSAP via a wireless network can include extra impacts to the network but not to the mobile device, which allows support for legacy mobile devices. However, SM transfer reliability and PSAP response reliability may not be high, SM transfer delay may be high and devices that are roaming or in limited service state may not be supported. Solutions that avoid these defects may be useful even if extra impacts to a mobile device are required.

### BRIEF SUMMARY

According to this description, an example method of sending an emergency Short Message Service (SMS) message, performed by a user equipment (UE), may include detecting a user input at the UE to send the emergency SMS message, and, responsive at least in part to the detecting the user input, establishing an emergency call with a Public Safety Answering Point (PSAP), wherein the emergency call comprises a Session Initiation Protocol (SIP) dialogue, wherein the SIP dialogue has no SIP media. The method may further comprise sending the emergency SMS message to the PSAP in association with the SIP dialogue.

An example method performed at a User Equipment (UE) of sending an emergency Short Message Service (SMS) message, according to this disclosure, comprises detecting a user input at the UE to send the emergency SMS message, and, responsive at least in part to the detecting the user input, establishing an emergency call with a Public Safety Answering Point (PSAP), wherein the emergency call comprises a Session Initiation Protocol (SIP) dialogue, wherein the SIP dialogue has no active SIP media session. The method further comprises sending the emergency SMS message to the PSAP in association with the SIP dialogue.

An example method at a server for supporting the sending of an emergency Short Message Service (SMS) message by a user equipment (UE), according to this disclosure, comprises receiving a Session Initiation Protocol (SIP) INVITE message from the UE, wherein the SIP INVITE indicates no active SIP media session, the method further comprises determining, based at least in part on one or more contents of the SIP INVITE message, that the SIP INVITE is being sent to establish a SIP dialogue to enable transfer of emergency SMS messages. The method also comprises routing the SIP INVITE message toward a Public Safety Answering Point (PSAP) that is able to support a SIP dialogue for transfer of emergency SMS messages.

An example User Equipment (UE), according to this disclosure, comprises at least one transceiver; at least one memory; and at least one processor communicatively coupled with the at least one transceiver and the at least one memory. The at least one processor is configured to detect a user input at the UE to send an emergency Short Message Service (SMS) message, and, responsive at least in part to the detecting the user input, establish an emergency call with a Public Safety Answering Point (PSAP) via the at least one transceiver, wherein the emergency call comprises a Session Initiation Protocol (SIP) dialogue, wherein the SIP dialogue has no active SIP media session. The at least one processor is also configured to send the emergency SMS message via the at least one transceiver to the PSAP in association with the SIP dialogue.

An example server, according to this disclosure, comprises at least one transceiver; at least one memory; and at least one processor communicatively coupled with the at least one transceiver and the at least one memory. The at least one processor is configured to receive a Session Initiation Protocol (SIP) INVITE message via the at least one transceiver from a user equipment (UE), wherein the SIP INVITE indicates no active SIP media session. The at least one processor is further configured to determine, based at least in part on one or more contents of the SIP INVITE message, that the SIP INVITE is being sent to establish a SIP dialogue to enable transfer of emergency Short Message Service (SMS) messages. The at least one processor is also configured to route the SIP INVITE message toward a Public Safety Answering Point (PSAP) that is able to support a SIP dialogue for transfer of emergency SMS messages.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of an embodiment of a communication system capable of transmitting an emergency short message service (ESMS) message according to the techniques described herein.

FIG. 2 is a simplified illustration of a Long Term Evolution (LTE) communication system capable of transmitting an ESMS message according to the techniques described herein.

FIG. 3 is a diagram showing a solution for Emergency SMS over Internet Protocol (IP) Multimedia Subsystem (IMS), according to an embodiment.

FIG. 4 is a diagram showing another solution for Emergency SMS over Internet Protocol (IP) Multimedia Subsystem (IMS), according to an embodiment.

FIG. 5 is a block diagram of an embodiment of a UE.

FIG. 6 is a block diagram of an embodiment of a computer system.

FIG. 7 is a flow diagram of a method performed at a UE of sending an emergency SMS message, according to an embodiment.

FIG. 8 is a flow diagram of a method performed at a server for supporting the sending of an emergency SMS message by a UE, according to an embodiment.

Like reference symbols in the various drawings indicate like elements, in accordance with certain example implementations. In addition, multiple instances of an element may be indicated by following a first number for the element with a hyphen and a second number. For example, multiple instances of an element 180 may be indicated as 180-1, 180-2, 180-3 etc. When referring to such an element using only the first number, any instance of the element is to be understood (e.g., element 180 in the previous example would refer to elements 180-1, 180-2, and 180-3). Drawings may be simplified for discussion purposes and may not reflect certain features of embodiments (e.g., sizes/dimensions, components, etc.) used in real-world applications. Additionally, operations within some procedures illustrated in the figures may be shown as numerals and referred to herein as stages (which may or may not be separately labeled in the figures).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

It can be noted that grammar usage herein generally follows American grammatical rules. For example, commas or periods at the end of quoted text may be part of the quoted text, included for grammatical purposes, or both. Because this can cause clarity issues with respect to what characters are included in the quoted text, exceptions may be made herein to this rule and/or other grammatical rules in cases in which doing so provides added clarity.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE) in a 5G new radio (NR) network.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services.

Also, references made herein to “TS” documents (e.g., “TS 23.304”) refer to corresponding technical specifications of the 3rd Generation Partnership Project (3GPP).

Current solutions that have been defined and implemented for sending SMS messages from a UE to an emergency number (e.g., 911 or 112) and thus to a PSAP are not always reliable, may not work for in-bound roamers, can have long delays, and may not support UE location reliably. These solutions can also have the following other limitations:
1. May not reliably support timely SMS replies from the PSAP to the user.
2. May not support an SMS transfer for a UE in limited service state (LSS).
3. May not enable a voice session to the same PSAP operator to be added by the user at a later time.
4. May be susceptible to spoofing where, on the PSAP side, any mobile terminated (MT) SMS message directed to the PSAP might be accepted without any filtering or verification. That could lead to Denial of Service (DoS) attacks and fake emergencies for public safety (e.g., swatting).

These and other drawbacks are addressed by embodiments described herein for providing reliable emergency SMS messaging over IMS. Various aspects relate generally to emergency SMS messaging. Some aspects more specifically relate to emergency SMS messaging using a Session Initiation Protocol (SIP) dialogue. In some examples, a UE can detect an input to send an SMS message (referred to here as an “emergency SMS message” or “emergency SM”) to an emergency number and, responsive at least in part to the detecting the user input, establish an emergency call with a PSAP. According to some aspects, the emergency call comprises a SIP dialogue, where the SIP dialogue has no SIP media (e.g., no voice bearer). According to some embodiments, the SIP dialogue may be established using an Internet Protocol (IP) Multimedia Subsystem (IMS). Such embodiments may involve performing an IMS Emergency Registration. Some embodiments may include performing an attach or emergency attach in a fourth-generation (4G) cellular network or performing a registration or an emergency registration in a fifth-generation (5G) or later sixth-generation (6G) cellular network. In some embodiments, a voice bearer may be added subsequently. These and other aspects are described below in further detail.

Particular aspects of the subject matter described in this disclosure can be implemented to realize one or more of the following potential advantages. In some examples, by establishing a SIP dialogue with no active SIP media, the described techniques can be used to send an SMS message to a PSAP in a more reliable manner than traditional techniques, as well as enabling fast and reliable PSAP SMS replies. Further, by leveraging the reuse of IMS emergency calls, embodiments can have reduced susceptibility to spoofing. These and other advantages will be apparent to a person of ordinary skill in the art in view of the following description.

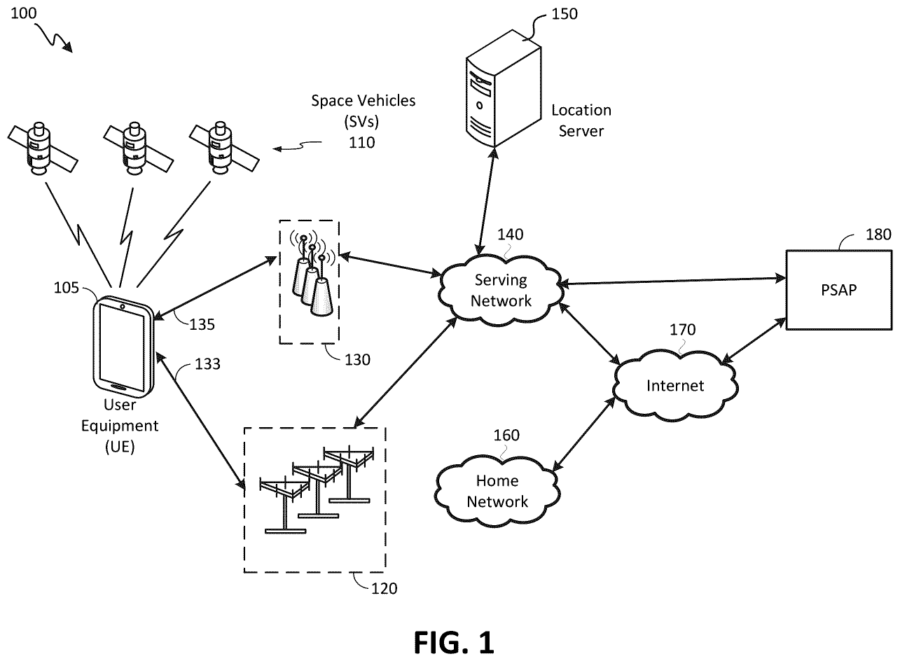

FIG. 1 is a simplified illustration of an embodiment of a communication system 100 capable of transmitting an emergency SMS (ESMS) message according to the techniques described herein. More specifically, the techniques described herein may be implemented by one or more components of the communication system 100. The communication system 100 can include a UE 105, one or more space vehicles (SVs) 110, one or more base stations 120, one or more access points 130, a serving network 140, a location server 150, a home network 160, the Internet 170, and a PSAP 180.

It should be noted that FIG. 1 provides only a generalized illustration of various components, any or all of which may be utilized as appropriate, and each of which may be duplicated (or absent) as necessary. Specifically, although only one UE 105 is illustrated, it will be understood that many UEs (e.g., hundreds, thousands, millions, etc.) may utilize the communication system 100. Similarly, the communication system 100 may include a larger or smaller number of base stations 120 and/or APs 130 than illustrated in FIG. 1. The illustrated connections that connect the various components in the communication system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the location server 150 may be incorporated into the serving network 140. Additionally or alternatively, depending on the capabilities of the UE 105, radio access technologies (RATs) other than those shown in and described in FIG. 1 may be available to the UE 105 for communicating with the PSAP 180. A person of ordinary skill in the art will recognize many modifications to the components illustrated.

The UE 105 may comprise and/or be referred to herein as a device, a mobile device, a wireless device, a mobile terminal, a terminal, a mobile station (MS), a Secure User Plane Location (SUPL) Enabled Terminal (SET), or by some other name. Moreover, UE 105 may correspond to a cellphone, smartphone, laptop, tablet, PDA, tracking device or some other portable or moveable device. Typically, though not necessarily, the UE 105 may support wireless communication such as using GSM, Code Division Multiple Access (CDMA), Wideband CDMA (WCDMA), LTE, High Rate Packet Data (HRPD), WiFi (also referred to as Wi-Fi), NR, Bluetooth® (BT), Worldwide Interoperability for Microwave Access (WiMAX), etc. The UE 105 may also support wireless communication using a Wireless Local Area Network (WLAN) which may connect to other networks (e.g., the Internet 170) using a Digital Subscriber Line (DSL) or packet cable, for example. As indicated above, one or more of these RATs may enable the UE 105 to communicate with the PSAP 180.

The UE 105 may comprise a single entity or may comprise multiple entities such as in a personal area network where a user may employ audio, video, and/or data I/O devices and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude) which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor).

Serving network 140 (also referred to as a serving Public Land Mobile Network (PLMN)) may provide wireless access to UE 105 (e.g., using any of the RATs described previously). Home network 160 (also referred to as a home PLMN or HPLMN) may be a network with which the user of UE 105 maintains a subscription for wireless services. When UE 105 is served by home network 160, networks 140 and 160 may be the same network.

Depending on desired functionality, the serving network 140 and home network 160 may comprise any of a variety of wireless and/or wireline networks. These networks 140 and 160 can, for example, comprise any combination of public and/or private networks, local and/or wide-area networks, and the like. Furthermore, networks 140 and 160 may utilize one or more wired and/or wireless communication technologies. In some embodiments, the networks 140 and 160 may comprise a cellular network, some other wireless wide area network (WWAN) network and/or a wireless local area network (WLAN), for example. Particular examples of networks 140 and 160 include an LTE wireless network, a Fifth Generation (5G) wireless network (also referred to as New Radio (NR) wireless network), a WiFi network, WLAN, and the Internet. LTE, GSM, W-CDMA, 5G and NR are wireless technologies defined by the Third Generation Partnership Project (3GPP). Networks 140 and 160 may also include more than one network and/or more than one type of network.

Under non-emergency situations, the UE 105 can communicate with the home network 160 for authentication and authorization purposes. This communication from the UE 105 to the home network 160 may be made via the serving network 140 and Internet 170. (It will be understood, however, that the configuration of the serving network 140, home network 160, and/or Internet 170 can vary, depending on desired functionality.) The home network 160 (and serving network 140) may provide an IP multimedia subsystem (IMS) and/or other services. As discussed in further detail below, the home network 160 may be bypassed during emergency calls for both voice channel establishment and for the transmission of an emergency SMS to the PSAP 180, in accordance with the techniques disclosed herein.

The base stations 120 and access points (APs) 130 are communicatively coupled to the serving network 140 and may be considered to be part of the serving network 140 (though they are shown separately for greater clarity). Depending on the technology of the serving network 140, a base station 120 may comprise a Node B, an Evolved Node B (also referred to as an eNodeB or eNB), a gNB, a base transceiver station (BTS), a radio base station (RBS), or the like. A base station 120 may support a WWAN technology or RAT such as GSM, WCDMA, LTE, or 5G New Radio (NR). An AP 130 may comprise a WiFi AP or a Bluetooth AP. Thus, the UE 105 can send and receive information to and from network-connected devices, such as the location server 150, by accessing the serving network 140 via a base station 120 using a first communication link 133. Additionally or alternatively, because APs 130 also may be communicatively coupled with the serving network 140, the UE 105 may communicate with network-connected devices, including the location server 150, using a second communication link 135.

The location server 150 may comprise a server and/or other computing device configured to determine a location estimate for the UE 105 and/or provide data (e.g., “assistance data”) to the UE 105 to facilitate the location determination. According to some embodiments, the location server 150 may comprise a Secure User Plane Location (SUPL) Location Platform (SLP) server, which may support the SUPL user plane (UP) location solution defined by the Open Mobile Alliance (OMA) and may support location services for UE 105 based on subscription information for UE 105 stored in the location server 150. The location server 150 may also comprise an Enhanced Serving Mobile Location Center (E-SMLC) that supports location of UE 105 using a control plane (CP) location solution for LTE access by UE 105. The location server 150 may further comprise a Location Management Function (LMF) that supports location of UE 105 using a control plane (CP) location solution for 5G or NR wireless access by UE 105. In a CP location solution, signaling to control and manage the location of UE 105 may be exchanged between elements of serving network 140, and with UE 105, using existing network interfaces and protocols and as signaling from the perspective of serving network 140. In a UP location solution, signaling to control and manage the location of UE 105 may be exchanged between location server 150 and UE 105 as data (e.g., data transported using the Internet Protocol (IP) or Transmission Control Protocol (TCP) and IP (TCP/IP)) from the perspective of serving network 140.

A UE 105 may include its location or a message from a user of the UE 105 in an emergency SMS message sent to the PSAP 180. The location may be obtained using any of a variety of techniques. In some implementations, a UE 105 may have circuitry and processing resources capable of obtaining location-related measurements (e.g., for signals received from SVs 110, APs 130, and/or base stations 120) and, in some embodiments, computing a position fix or estimated location of the UE 105 based on these location related measurements. In some implementations, location-related measurements obtained by the UE 105 may be transferred to the location server 150 after which the location server 150 may estimate or determine a location for the UE 105 based on the measurements. Location-related measurements obtained by the UE 105 may include measurements of signals received from SVs 110 belonging to a Satellite Positioning System (SPS) or Global Navigation Satellite System (GNSS) such as the Global Positioning System (GPS), GLONASS, Galileo or Beidou, and/or may include measurements of signals received from terrestrial transmitters fixed at known locations (e.g., such as base stations 120 and/or APs 130). The UE 105 and/or location server 150 may then obtain a location estimate for the UE 105 based on these location-related measurements using any one of several known position methods such as, for example, GNSS, Assisted GNSS (A-GNSS), Observed Time Difference Of Arrival (OTDOA), Angle of Arrival (AoA), Angle of Departure (AoD), Enhanced Cell ID (E-CID), or combinations thereof.

In some of these techniques (e.g., GNSS, A-GNSS, and OTDOA), pseudoranges or timing differences may be measured at the UE 105 relative to three or more terrestrial transmitters fixed at known locations or relative to four or more satellites with accurately known orbital data, or combinations thereof, based at least in part, on pilots, navigation signals, positioning reference signals (PRS) or other positioning related signals transmitted by the transmitters or satellites and received at the UE 105. Here, the location server 150 may be capable of providing positioning assistance data to the UE 105 including, for example, information regarding signals to be measured (e.g., signal timing, frequency, coding, and/or bandwidth), locations and identities of terrestrial transmitters and/or signal, timing and/or orbital information for GNSS satellites to facilitate positioning techniques such as A-GNSS, OTDOA, AoD and E-CID. For example, the location server 150 may comprise an almanac that indicates locations and identities of base stations 120 and/or APs 130 in a particular region or regions such as a particular venue and may provide information descriptive of signals transmitted by one or more of the terrestrial transceivers (e.g., base stations 120 and/or APs 130) such as transmission power and signal timing. In the case of positioning using E-CID, the UE 105 may obtain measurements of signal strengths for signals received from terrestrial transceivers and/or may obtain a round trip signal propagation time (RTT) between the UE 105 and a terrestrial transceiver.

The UE 105 may use the measurements obtained for signals received from satellites and/or terrestrial transceivers (or transmitters) together with assistance data (e.g., terrestrial almanac data or GNSS satellite data such as GNSS Almanac and/or GNSS Ephemeris information) received from the location server 150 to determine a location for the UE 105 or may transfer the measurements to the location server 150 to perform the same determination. An emergency and/or SMS message sent from the UE 105 may be routed to or towards the PSAP 180 based on the location of the UE. For example, the PSAP 180 may be a PSAP whose public safety service area includes the location that was determined for the UE 105.

The PSAP 180, as represented in FIG. 1, may comprise one or more devices or servers to which emergency calls and/or SMS messages may be routed. Furthermore, although FIG. 1 illustrates the PSAP 180 as having separate connections with both the serving network 140 and the Internet 170, other configurations are possible. In some embodiments, the PSAP 180 may be directly connected with only one or the other.

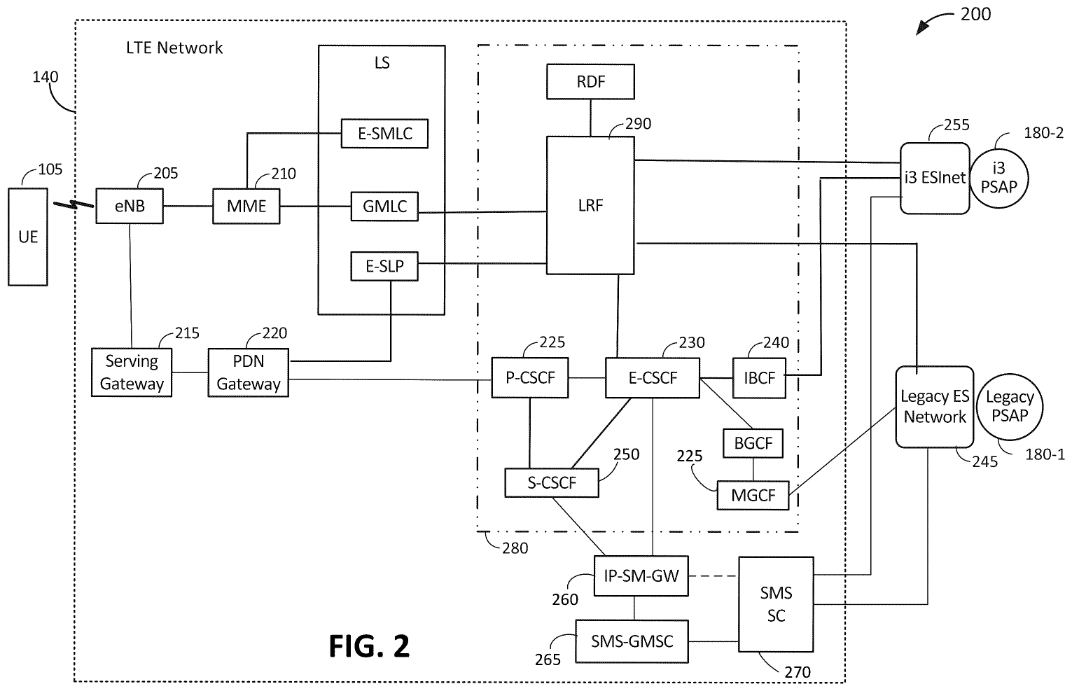

FIG. 2 is a simplified block diagram showing a communication system 200 that may be an example of the communication system 100 for the case that the serving network 140 supports LTE access for a UE 105. In this case, the serving network 140 may be referred to as an Evolved Packet System (EPS)). Communication system 200 includes a Legacy Emergency Services (ES) Network 245 attached to a Legacy PSAP 180-1, and a National Emergency Number Association (NENA) i3 Emergency Services IP network (ESInet) 255 attached to a NENA i3 capable PSAP 180-2. The serving network 140 may include an Evolved Node B (eNodeB, or eNB) 205 which may correspond to a base station 120, a Serving Gateway 215, a Packet Data Network (PDN) Gateway 220, a Mobility Management Entity (MME) 210, a Proxy Call Session Control Function (P-CSCF) 225, an Emergency Call Session Control Function (E-CSCF) 230, a Media Gateway Control Function (MGCF) 235, an Interconnection Border Control Function (IBCF) 240, a Serving Call Session Control Function (S-CSCF) 250, a Location Retrieval Function (LRF) 290, an IP Short Message Gateway (IP-SM-GW) 260, an SMS Gateway Mobile Switching Center (SMS-GMSC) 265 and an SMS Service Center (SMS SC) 270. In some embodiments, the MGCF 235 may be incorporated into or otherwise joined with a Media Gateway (MGW) (not shown in FIG. 2). The communication system 200 may comprise other components (some of which are shown in FIG. 2 but which are not discussed in this disclosure), and other embodiments may add, omit, join, separate, rearrange, or otherwise alter components depending on desired functionality. As previously noted, embodiments herein may be implemented in other types of networks and/or communication systems, such as a fifth-generation (5G) New Radio (NR) network. Such variations will be recognized by a person of ordinary skill in the art.

The eNB 205 may be a serving eNB for the UE 105 and may provide wireless communications access to the serving network 140 on behalf of UE 105. The MME 210 may be a serving MME for the UE 105 and may support mobility of UE 105 and provision of signaling access and voice bearer paths to UE 105. The serving gateway 215 and PDN gateway 220 may provide IP based signaling and IP transport support for UE 105—e.g., with PDN gateway 220 assigning an IP address for UE 105 and providing IP access to other entities in serving network 140 such as P-CSCF 225.

Serving network 140 may include an IP Multimedia Subsystem (IMS) 280 that may include the P-CSCF 225, E-CSCF 230, MGCF 235, IBCF 240, S-CSCF 250, and LRF 290. IMS 280 may support an IMS emergency services call from UE 105 to a PSAP 180 such as i3 PSAP 180-2 or legacy PSAP 180-1. For example, in the case of an IMS emergency services call from UE 105 to i3 PSAP 180-2, a signaling path (not shown in FIG. 2) from UE 105 may pass through the eNB 205, serving gateway 215, PDN gateway 220, P-CSCF 225, E-CSCF 230, IBCF 240, the i3 ESInet 255, and i3 PSAP 180-2. In the case of an IMS emergency services call from UE 105 to legacy PSAP 180-1, a signaling path (not shown in FIG. 2) from UE 105 may pass through the eNB 205, serving gateway 215, PDN gateway 220, P-CSCF 225, E-CSCF 230, a Breakout Gateway Control Function (BGCF), MGCF 235, the legacy ES Network 245, and legacy PSAP 180-1.

Elements in IMS 280 may provide call handling and call routing support to enable an IMS emergency services call from UE 105 to either i3 PSAP 180-2 or legacy PSAP 180-1. For example, P-CSCF 225 may detect an IMS emergency services call when instigated by UE 105 (e.g., by receiving, decoding, and interpreting a SIP INVITE message sent by UE 105). E-CSCF 230 may support routing of an IMS emergency services call from UE 105 (e.g., by sending a SIP INVITE received via P-CSCF 225 from UE 105 towards either legacy PSAP 180-1 via MGCF 235 or i3 PSAP 180-2 via IBCF 240). LRF 290 may assist routing of an IMS emergency services call from UE 105 when queried by E-CSCF 230. For example, LRF 290 may determine a location for UE 105 (e.g., from information provided by UE 105 in a SIP INVITE) and may determine a PSAP (e.g., legacy PSAP 180-1 or i3 PSAP 180-2) that supports an emergency services call for that location and may return an identity or address for this PSAP to E-CSCF 230. MGCF 235 may perform conversion of SIP-based signaling, received from or sent to UE 105, to or from signaling used by ES network 245, such as Integrated Services Digital Network (ISDN) User Part (ISUP) signaling in the case of an emergency services call to legacy PSAP 180-1. For example, MGCF 235 may convert an IMS emergency services call received from UE 105 into a Circuit Switched (CS) emergency services call in the case of an IMS emergency services call routed to legacy PSAP 180-1.

I3 ESInet 255 may support IP-based emergency calls from UE 105 on behalf of i3 PSAP 180-2—e.g., may route an IP-based emergency services call from UE 105 to i3 PSAP 180-2. Legacy ES network 245 may similarly support Circuit Switched (CS) based emergency calls on behalf of legacy PSAP 180-1 received via MGCF 235 from UE 105—e.g., may route a CS emergency services call from UE 105 received via MGCF 235 to legacy PSAP 180-1. An MGW connected to MGCF 235 (not shown in FIG. 2) may convert between a Voice over IP (VoIP) bit stream received from or sent to UE 105 and a CS-based voice bit stream sent to or received from legacy PSAP 180-1 in the case of an emergency services call from UE 105 to legacy PSAP 180-1.

IP-SM-GW 260 may serve as a gateway to route IP-based SMS messages received from UE 105 to or towards an SMS service center (SMS SC or SMSC) 270 and IP based SMS messages received from SMS SC 270 to or towards UE 105. Functions of the IP-SM-GW 260 can include (i) providing protocol interworking for the transfer of an SMS message or ESMS message between UE 105 and SMS SC 270, (ii) determining the domain (e.g., CS, packet switched (PS), or IMS) for delivery of an SMS or ESMS message (e.g., to UE 105 or PSAP 180), (iii) connecting to the SMS-GMSC 265 using established Mobile Application Part (MAP) or Diameter based protocols, (iv) appearing to (e.g., connecting to) the SMS-GMSC 265 as a Mobile Switching Center (MSC), Serving General Packet Radio Service (GPRS) Support Node (SGSN) or MME, (v) connecting to a Home Subscriber Server (HSS—not shown in FIG. 2) using established MAP or Diameter based protocols to obtain MSC/SGSN/MME address(es) for SMS termination, and/or (vi) acting as an Application Server towards the IMS 280.

SMS-GMSC 265, which may also function as (or be referred to as) an SMS Interworking MSC (SMS-IWMSC), may transfer SMS messages to and from SMS SC 270 and may serve as the access node in serving network 140 that provides access to SMS SC 270 using standardized protocols.

SMS SC 270 may provide a store and forward capability for SMS message transfer for serving network 140 by receiving SMS messages sent by UEs subscribed to serving network 140 and forwarding the SMS messages to their destinations, such as other UEs or clients and servers access via a wireline network. In a conventional embodiment of communication system 200, when UE 105 is subscribed to serving network 140 (e.g., serving network 140 is the same as home network 160), an SMS message sent by UE 105 may be routed to SMS SC 270 via P-CSCF 225, S-CSCF 250, IP-SM-GW 260, and SMS-GMSC 265. For example, UE 105 may send the SMS message within a SIP MESSAGE to S-CSCF 250 via P-CSCF 225. S-CSCF 250 may forward the SIP MESSAGE to IP-SM-GW 260, which may extract the SMS message and forward the SMS message to SMS-GMSC 265. SMS-GMSC 265 may then forward the SMS message to SMS SC 270. SMS SC 270 may then forward the SMS message to a destination indicated by a destination address (e.g., a directory number such as a Mobile Station International Subscriber Directory Number (MSISDN)) in the SMS message which may in some scenarios involve forwarding through similar or identical entities to those used to forward the SMS message to SMS SC 270 but in a reverse order (e.g., may involve forwarding through an SMS-GMSC, IP-SM-GW, S-CSCF, P-CSCF to a UE which may be associated with serving network 140 or with some other network).

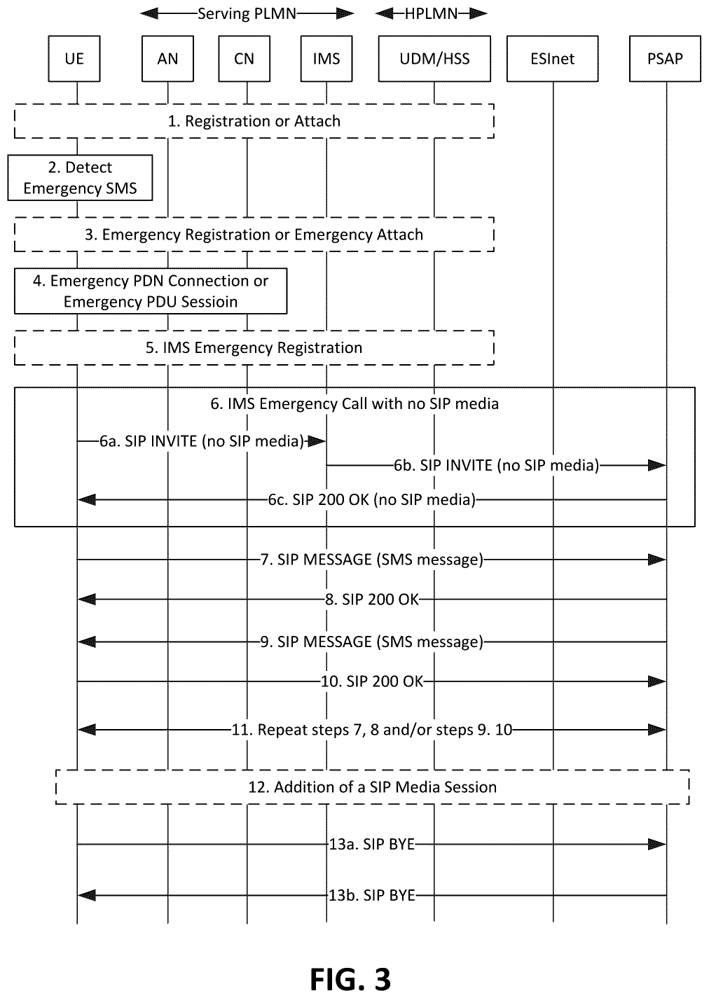

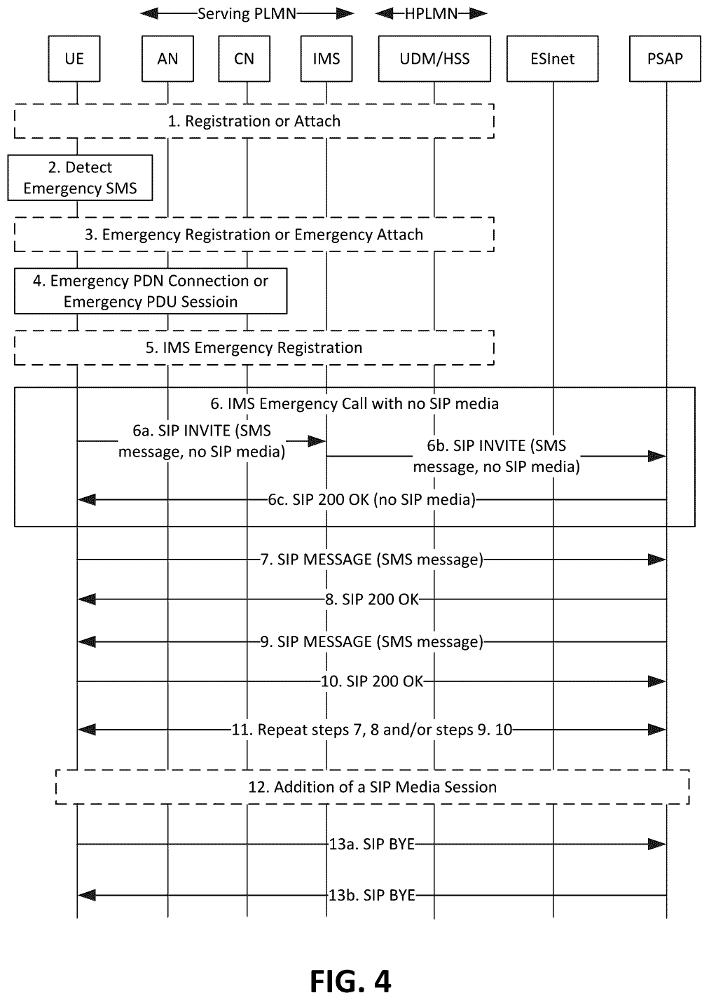

Cellular networks, such as those shown in FIGS. 1 and 2, described above, can provide for sending SMS messages from a UE to a PSAP. However, as previously noted, previous solutions that have been defined and implemented for sending SMS messages from a UE to a PSAP are not always reliable, may not work for inbound roamers, can have long delays, and may not support UE location reliably. A more reliable solution for support of emergency SMS messages is described next in association with FIGS. 3 and 4.

FIG. 3, shows one solution for support of emergency SMS messages using IMS. FIG. 3 includes a UE (e.g., a UE 105); an ESInet (Emergency Services IP network) such as i3 ESInet 255; an access network (AN) which may include eNBs 205, gNBs, or WiFi APs; a core network (CN) such as LTE network 140 in FIG. 2 excluding eNB 205; an IMS such as IMS 280, a serving PLMN such as serving network 140; an HPLMN such as home network 160; and a PSAP that is IP capable such as i3 PSAP 180-2. Optional functionality is illustrated with dashed lines and may be implemented, depending on the desired functionality of the implementation. Further, alternative embodiments may alter and/or rearrange various operations, depending on desired functionality, including performing one or more operations in parallel. FIG. 3 shows different numbered stages of operation as described below.

Stage 1 in FIG. 3. The UE (e.g., a UE 105) attaches (4G) or registers (5G) with the serving PLMN (e.g., serving PLMN 140) if subscribed for access and can be authenticated. The UE may receive an indication during the 5G registration or 4G Attach procedure that the serving PLMN and at least one PSAP reachable from the serving PLMN support Emergency SMS over IMS. Alternatively, or in addition, the serving PLMN may broadcast System Information Block (SIB) information (e.g., in a SIB1) indicating support for Emergency SMS over IMS in a limited service state (LSS) of a UE and/or in a normal state. A UE in LSS may not be allowed by a serving network to access normal services such as originating and receiving voice calls or sending and receiving data or non-emergency SMS messages, but may be allowed to originate an emergency voice call and/or send an ESMS message. A UE in a normal state may be allowed to access normal services as well as emergency related services like ESMS.

Stage 2. The UE detects that a user of the UE has created a short message (SM) (also referred to as an SMS message or emergency SMS message) and has instigated sending of this message to an emergency number (e.g., “911” or “112”). The UE can be aware of serving PLMN and local PSAP support for emergency SMS over IMS from stage 1.

Stage 3. The UE performs an emergency attach (e.g. for 4G LTE access) or an emergency registration (e.g. for 5G NR access) if unable to attach or register in stage 1 (e.g., if the UE was in LSS). This stage may only apply if the serving PLMN broadcasts (e.g., in a SIB1) an indication of support for emergency SMS over IMS in limited service state and may not occur if there is no support for that.

Stage 4. The UE establishes an emergency PDN connection (e.g. for 4G LTE access) or an emergency PDU session (e.g. for 5G NR access).

Stage 5. The UE attempts to perform an IMS Emergency Registration with the serving network and home network (if different to the serving network) if stage 1 occurred or if authentication of the UE occurred successfully in stage 3.

Stage 6. The UE establishes an IMS emergency call with no SIP media to an IP capable PSAP (e.g., i3 PSAP 180-2).

Stage 6a. As part of stage 6, the UE sends a SIP INVITE to a P-CSCF (e.g., P-CSCF 225) in the IMS (e.g., IMS 280), which forwards the SIP INVITE to an E-CSCF (e.g., E-CSCF 230). The UE includes in the SIP INVITE (e.g., in a SIP To header and in a SIP Request-URI header) the emergency number detected at stage 2 or an SOS service Uniform Resource Name (URN) (e.g., “urn:service:sos”) corresponding to this number. The SIP INVITE indicates that an active SIP media session, such as for voice, text or video, will not be established. The SIP INVITE may contain a SIP header parameter denoted SHP here, which may be a new SIP header, indicating that the SIP INVITE is being sent to establish a SIP dialogue to enable later transfer of text messages, SMS messages, emergency text messages, and/or emergency SMS messages. The SIP INVITE may also include an indication IND (e.g., in an Accepts SIP header) that the UE is able to receive and/or send emergency SMS messages. The SIP INVITE may optionally include a SIP Priority header field with a value of “emergency,” “emergency SMS,” or some other value indicating use of emergency SMS. In some embodiments, neither the SHP nor IND are included.

Stage 6b. The E-CSCF routes the SIP INVITE to or towards a PSAP based on the included emergency number or SOS URN and, in some instances, based also on a location or current serving cell for the UE and, in some instances, with the assistance of an LRF (e.g., LRF 290). The E-CSCF may further infer from the contents of the SIP INVITE, such as the emergency number or SOS URN, the SIP header SHP if included, the indication IND if included, and/or the indication that an active SIP media session will not be established, that the SIP INVITE is being sent to establish a SIP dialogue to enable transfer of emergency SMS messages. Based on this inference, the E-CSCF may route the SIP INVITE to or towards a PSAP that is able to support a SIP dialogue for the transfer of emergency SMS messages. For example, a routing address of this PSAP may have been configured in the E-CSCF or in an LRF when the E-CSCF obtains routing assistance from an LRF. If the E-CSCF is unable to route the SIP INVITE to or towards a PSAP that is able to support a SIP dialogue for transfer of an emergency SMS message, stage 6b and later stages in FIG. 3 may not occur, and the E-CSCF may instead return a SIP error message (e.g., a SIP 4xx, 5xx, or 6xx response) to the UE. The UE may then indicate an error to the user or may use some other method (e.g. a less reliable method) to attempt to send the ESMS message to a PSAP.

Stage 6c. The PSAP may recognize from the SIP INVITE message received at stage 6b that the UE is able to send and receive emergency SMS messages and that the SIP INVITE message was sent to establish a SIP dialogue to enable transfer of emergency SMS messages. This recognition may be based on the contents of the SIP INVITE, such as the emergency number or SOS URN, the SIP header SHP if included, the indication IND if included and/or the indication that an active SIP media session will not be established. Based on this recognition, the PSAP returns a SIP 200 OK to the UE via the E-CSCF and P-CSCF that also indicates that an active SIP media session will not be established. The SIP 200 OK may indicate (e.g., in an Accepts SIP header or in a SIP header similar to or the same as the SIP header SDP in the SIP INVITE) that the PSAP is able to receive and/or send emergency SMS messages. Alternatively, the SIP 200 OK may be an implicit indication that the PSAP is able to receive and send emergency SMS messages.

Stage 7. The UE sends the emergency SMS message to the PSAP inside a SIP MESSAGE in association with the SIP dialogue established at stage 6. The SIP MESSAGE carrying the emergency SMS message may thus be sent through the IMS and ESInet.

Stage 8. The PSAP returns a SIP 200 OK or, in some instances, a SIP 202 to acknowledge receipt of the SMS MESSAGE and in association with the SIP dialogue established at stage 6. The SIP 200 OK may thus also be sent through the ESInet and IMS back to the UE.

Stage 9. The PSAP optionally returns an SMS message reply to the UE inside a SIP MESSAGE in association with the SIP dialogue. The SIP MESSAGE may thus be sent through the ESInet and IMS to the UE.

Stage 10. The UE returns a SIP 200 OK to acknowledge receipt of the SMS MESSAGE and in association with the SIP dialogue. The SIP 200 OK may thus be sent through the IMS and ESInet to the PSAP.

Stage 11. The UE and PSAP may exchange further SMS messages using SIP MESSAGEs as in stages 7 to 10.

Stage 12. The UE or the PSAP may optionally add a SIP media session (e.g., for voice) at any time after stage 6 by sending a SIP INVITE to the other party via the IMS and ESInet, where the SIP INVITE includes a Session Description Protocol (SDP) description for the SIP media session. The other party (i.e. the other of the UE or the PSAP) can then return a SIP 200 OK with an SDP description for the same SIP media session which confirms the SIP media session. The UE and the PSAP would then establish the SIP media session using IP and other protocols (e.g., Real-time Transport Protocol (RTP), RTP Control Protocol (RTCP)) and may use the media session to exchange speech or other media (e.g., video). The UE and the PSAP can still exchange SMS messages according to stages 7 to 10.

Stage 13a. Following a timeout (e.g. 5 to 15 minutes) after sending or receipt of the last SMS message and, for example, when there is no media session, or when the user of the UE indicates a wish to end all communication with the PSAP, the UE sends a SIP BYE to the PSAP to release the SIP dialogue established at stage 6.

Stage 13b. Alternatively, the PSAP can send a SIP BYE at any time to release the SIP dialogue.

In some aspects, the indication, in the SIP INVITE at stage 6a and/or in the SIP 200 OK at stage 6c, that an active SIP media session will not be established can correspond to one of several alternatives, referred to here as ALT1, ALT2, and ALT3.

In a first alternative, ALT1, a Session Description Protocol (SDP) description for SIP media in the SIP INVITE, which is commonly referred to as an SDP offer, and a corresponding SDP description for SIP media in the SIP 200 OK, which is commonly referred to as an SDP answer, are both not included (i.e. are absent in the SIP INVITE and SIP 200 OK). ALT1 may conflict with current rules for correct usage of SIP (e.g., in IETF RFC 3261) where either (a) an SDP offer may be required to be included in a SIP INVITE with an SDP answer then required to be included in a SIP 200 OK, or (b) an SDP offer may be required to be included in a SIP 200 OK when not included in a SIP INVITE, with an SDP answer then required to be included in a SIP ACK (sent by the UE in FIG. 3 to acknowledge the SIP 200 OK at stage 6c). Although ALT1 can still be used, it may be less preferable as it can violate the above rules for correct usage of SIP.

In a second alternative, ALT2, the SDP description for SIP media in the SIP INVITE and the SDP description for SIP media in the SIP 200 OK are both included (e.g., for voice media) but include an indication of inactive media (e.g., via inclusion of a text line “a=inactive” in the SDP description as defined in IETF RFC 4566). This may result in the establishment of a media session (e.g., for voice) between the UE and PSAP after stage 6c, but where there is no transfer of any media content between the UE and PSAP. ALT2 may not always be suitable if the UE does not support any SIP media or if a media session (e.g., for voice) cannot be established between the UE and PSAP after stage 6c (e.g., due to insufficient network bandwidth or insufficient guaranteed Quality of Service (QoS)).

In a third alternative, ALT3, an SDP description for SIP media in the SIP INVITE and an SDP description for SIP media in the SIP 200 OK are both included but explicitly indicate that no media sessions are to be established between the UE and PSAP. To support ALT3, the SDP media descriptions in the SIP INVITE and SIP 200 OK may each contain zero media streams, which may be indicated by not including any media text lines in the SDP description, as described in IETF RFC 3264. As an example, a media text line that includes a character sequence “m=audio”, “m=text”, or “m=video” could normally be included as part of the SDP description in a SIP INVITE or SIP 200 OK to indicate a media session for audio (e.g., voice), text or video, respectively. With ALT3, no such media lines (i.e. no text lines with a starting character sequence “m=”) are included in the SDP description in either the SIP INVITE at stage 6a or the SIP 200 OK at stage 6c. This option is allowed in IETF RFC 4566 and RFC 3264 and can indicate that media streams for the session between the UE and the PSAP will be added at a later time in a modified offer. An SDP description can still be included in the SIP INVITE at stage 6a and in the SIP 200 OK at stage 6c for ALT3 and might include information such as a session name (“s=” text line), a bandwidth (“b=” text line), a timing (“t=” text line), and/or an originator and session identifier (“o=” text line). ALT3 may not be in conflict with the rules for SDP offer and answer usage in IETF RFC 3261 because an SDP offer and SDP answer are still included in a SIP INVITE and SIP 200 OK.

For a UE that does not detect the emergency SMS message at stage 2 (e.g., because the UE does not detect the destination number entered by the user for the emergency SMS message as being an emergency number), the UE may send the SMS message as a non-emergency SMS message in a SIP MESSAGE to a P-CSCF in the serving PLMN IMS, which may forward the SIP MESSAGE to an S-CSCF in the HPLMN, which in turn may forward the SIP MESSAGE to an IP-Short-Message-Gateway (IP-SM-GW) in the HPLMN. The IP-SM-GW can be configured with a list of emergency numbers that are checked against the incoming SIP MESSAGE. When the IP-SM-GW detects that the SMS message in the SIP MESSAGE is an emergency SMS message due to having an emergency destination number, it may check whether the UE supports emergency SMS over IMS. If the UE supports emergency SMS over IMS, the IP-SM-GW may respond with a SIP 380 message indicating emergency services which is forwarded to the UE. The UE, in turn, may then initiate the procedure in FIG. 3 or FIG. 4 starting at stage 2. If the UE does not support emergency SMS over IMS, the IP-SM-GW may forward the SMS message to an SMS-C in the HPLMN which, in turn, forwards the SMS message to a PSAP.

FIG. 4 shows a variant of the solution in FIG. 3 in which an emergency SMS message is included in a SIP INVITE message and optionally in a SIP 200 OK message. FIG. 4 shows a UE, an ESInet, an AN, a CN, an IMS, an HPLMN, and a PSAP, which correspond to the same entities shown in FIG. 3. Again, optional functionality is illustrated with dashed lines and may be implemented, depending on the desired functionality of the implementation. Further, alternative embodiments may alter and/or rearrange various operations, depending on desired functionality, including performing one or more operations in parallel. FIG. 4 shows different numbered stages of operation as described below.

Stages 1 to 5 in FIG. 4 can correspond to stages 1 to 5 in FIG. 3.

Stage 6. The UE establishes an IMS emergency call with no SIP media to an IP capable PSAP (e.g., i3 PSAP 180-2) as in FIG. 3 but can also transfer an SMS message.

Stage 6a. As part of stage 6, the UE sends a SIP INVITE to a P-CSCF (e.g., P-CSCF 225) in the IMS (e.g., IMS 280) which forwards the SIP INVITE to an E-CSCF (e.g., E-CSCF 230). The UE includes in the SIP INVITE (e.g., in a SIP To header and in a SIP Request-URI header) the emergency number detected at stage 2 or an SOS service URN (e.g., “urn:service:sos”) corresponding to this number. The SIP INVITE indicates that an active SIP media session, such as for voice, text or video, will not be established and may include SIP headers and/or parameters as described for stage 6a in FIG. 3. The indication that an active SIP media session will not be established may be supported using any of the alternatives, ALT1, ALT2, or ALT3, described for FIG. 3. In addition, and unlike FIG. 3, the UE includes the emergency SMS message created by the user at stage 2 in the SIP INVITE (e.g., in a message body part for the SIP INVITE).

Stage 6b. The E-CSCF routes the SIP INVITE to or towards a PSAP as at stage 6b for FIG. 3. As for FIG. 3, the E-CSCF may infer from the contents of the SIP INVITE that the SIP INVITE is being sent to establish a SIP dialogue to enable transfer of emergency SMS messages. However, unlike FIG. 3, the E-CSCF may make this inference based on the presence of the SMS message in the SIP INVITE as well as on other content of the SIP INVITE, such as the emergency number or SOS URN, the SIP header SHP if included, the indication IND if included and/or the indication that an active SIP media session will not be established. Based on this inference, the E-CSCF may then route the SIP INVITE to or towards a PSAP that is able to support a SIP dialogue for transfer of emergency SMS messages as in FIG. 3.

Stage 6c. As at stage 6c in FIG. 3, the PSAP may recognize from the SIP INVITE message received at stage 6b that the UE is able to send and receive emergency SMS messages and that the SIP INVITE message was sent to establish a SIP dialogue to enable the transfer of emergency SMS message. As in FIG. 3, this recognition may be based on the contents of the SIP INVITE, such as the emergency number or SOS URN, the SIP header SHP if included, the indication IND if included and/or the indication that an active SIP media session will not be established. However, unlike FIG. 3, the recognition may be further or alternatively based on the presence of the SMS message in the SIP INVITE. Based on this recognition, the PSAP returns a SIP 200 OK to the UE via the E-CSCF and P-CSCF that also indicates that an active SIP media session will not be established as at stage 6c in FIG. 3. But, unlike FIG. 3, the PSAP may include an SMS message in the SIP 200 OK (e.g., in a message body part of the SIP 200 OK). The SMS message included in the SIP 200 OK may be pre-configured in the PSAP in some aspects and may contain text indicating that the PSAP has received the SMS message sent by the UE at stage 6a and that the PSAP will respond to the UE later with more information. The SMS message sent at stage 6c may reassure the user of the UE that the PSAP is acting on the SMS message sent by the user.

In some aspects, the SIP INVITE sent at stage 6a may, as at stage 6a in FIG. 3, not include the emergency SMS message, but the 200 OK, sent at stage 6c, may include an emergency SMS message from the PSAP as described above.

As in FIG. 3, the SIP 200 OK sent at stage 6c may indicate (e.g., in an Accepts SIP header or in a SIP header similar to or the same as the SIP header SDP in the SIP INVITE) that the PSAP is able to receive and/or send emergency SMS messages. Alternatively, an SMS message included in the SIP 200 OK may be an implicit indication that the PSAP is able to receive and send emergency SMS messages.

Stage 7. The UE may send a further SMS message to the PSAP in a SIP MESSAGE in association with the SIP dialogue established at stage 6, as at stage 7 in FIG. 3.

Stage 8. The PSAP returns a SIP 200 OK or, in some instances, a SIP 202 to acknowledge receipt of the SMS MESSAGE and in association with the SIP dialogue established at stage 6, as at stage 8 in FIG. 3.

Stage 9. The PSAP may return an SMS message or a further SMS message to the UE in a SIP MESSAGE in association with the SIP dialogue, as at stage 9 in FIG. 3.

Stage 10. The UE returns a SIP 200 OK to acknowledge receipt of the SMS MESSAGE and in association with the SIP dialogue, as at stage 10 in FIG. 3.

In some aspects, stages 9 and 10 may precede stages 7 and 8.

Stage 11. The UE and PSAP may exchange further SMS messages using SIP MESSAGEs as in stages 7 to 10.

Stages 12, 13a and 13b may occur as described for FIG. 3.

The solutions shown in FIGS. 3 and 4 can provide improved support for transfer of SMS messages between a UE and a PSAP compared to previously defined and deployed solutions. The solutions can support immediate and reliable acknowledgement of each SMS message (using the 200 OK messages in FIGS. 3 and 4) which can allow the user of the UE and a PSAP operator to know that the other party has received each SMS message that was sent.

For normal IMS emergency calls, a UE location is often needed by a PSAP and may be sent to the PSAP using any of the following existing methods:
(a) A control plane solution defined in 3GPP TS 23.273 with 5G access, or a control plane solution defined in 3GPP TS 23.271 with 4G access or a SUPL solution defined in OMA-TS-ULP-V2_0_6-20200720-D, “UserPlane Location Protocol”, July 2020, with either 4G or 5G access.
(b) A SIP PUBLISH method defined in 3GPP TS 24.229 clause 5.1.6.12.
(c) A SIP INVITE and SIP UPDATE method defined in 3GPP TS 24.229 clauses 5.1.6.8.2, 5.1.6.8.3, 5.1.6.8. and 5.1.6.10.
(d) An Advanced Mobile Location (AML) solution defined in ETSI TS 103 625, “Advanced Mobile Location”.

For method (c), a SIP UPDATE in 3GPP TS 24.229 is restricted to an initially unrecognized IMS emergency call but could be extended to sending a UE location at any time for any type of IMS emergency call.

The solutions in FIGS. 3 and 4 can use any of these four methods to provide a UE location to the PSAP to which emergency SMS messages are sent. Method (a) may require network support. Method (d) may have no network impact, but may have reliability and delay problems. Method (c) may have no network impact.

The solutions shown in FIGS. 3 and 4 enable the PSAP to send SMS message replies back to the UE and with low delay.

In some cases, emergency SMS may be used when a previous voice emergency call fails or is unsuitable (e.g., due to excessive noise at the UE location or at a crime scene where the user needs to avoid being overheard). In such cases, a voice emergency call might become possible later. For the solutions shown in FIGS. 3 and 4, either the UE or the PSAP operator can add a voice bearer to the SIP dialogue for SMS at a later time, as at stage 12 in FIGS. 3 and 4.

Spoofing is a common problem for emergency calls (e.g., swatting), where an attacker may originate an emergency call to a PSAP, where the emergency call signaling (e.g. a SIP INVITE message) indicates a calling party number of some other user (and not the attacker) and may further indicate a location for the user that is different to the location of the attacker. However, if spoofing of a calling party number can be prevented, then the extent of spoofing could be reduced and spoofers could be identified. For normal IMS calls and IMS emergency calls, it can be possible to authenticate the calling party and to indicate the authentication to the called party, as defined in 3GPP TS 23.167 and 3GPP TS 24.229, thereby allowing a PSAP to receive a confirmation of the calling party number. The reverse is also possible whereby a PSAP callback can be authenticated and indicated to a UE. Since the solutions in FIGS. 3 and 4 are based on reuse of IMS emergency calls, they can have reduced susceptibility to spoofing by reusing authentication of the calling party number and of the PSAP as just described.

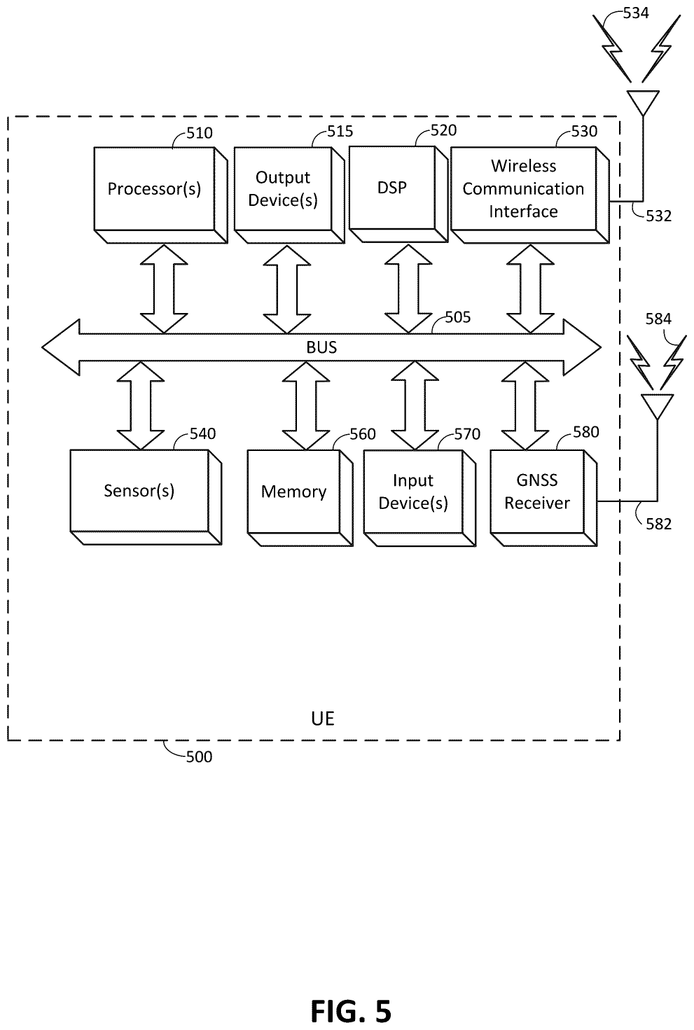

FIG. 5 is a block diagram of an embodiment of a UE 500 (e.g., a UE 105), which can be utilized as described herein (e.g., in association with the previously-described figures, with respect to a UE, mobile device, etc.). It should be noted that FIG. 5 is meant only to provide a generalized illustration of various components, any or all of which may be utilized as appropriate. Furthermore, the functionality of the UE discussed herein may be executed by one or more of the hardware and/or software components illustrated in FIG. 5.

The UE 500 is shown comprising hardware elements that can be electrically coupled via a bus 505 (or may otherwise be in communication, as appropriate). The hardware elements may include a processor(s) 510 which can include without limitation one or more general-purpose processors (e.g., an application processor), one or more special-purpose processors (such as DSP chips, graphics acceleration processors, application specific integrated circuits (ASICs), and/or the like), and/or other processing structures or means. Processor(s) 510 may comprise one or more processing units, which may be housed in a single integrated circuit (IC) or multiple ICs. As shown in FIG. 5, some embodiments may have a separate DSP 520, depending on desired functionality. Location determination and/or other determinations based on wireless communication may be provided in the processor(s) 510 and/or wireless communication interface 530 (discussed below). The UE 500 also can include one or more input devices 570, which can include without limitation one or more keyboards, touch screens, touch pads, microphones, buttons, dials, switches, and/or the like; and one or more output devices 515, which can include without limitation one or more displays (e.g., touch screens), light emitting diodes (LEDs), speakers, and/or the like.

The UE 500 may also include a wireless communication interface 530, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 500 to communicate with other devices as described in the embodiments above. The wireless communication interface 530 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 532 that send and/or receive wireless signals 534. According to some embodiments, the wireless communication antenna(s) 532 may comprise a plurality of discrete antennas, antenna arrays, or any combination thereof. The antenna(s) 532 may be capable of transmitting and receiving wireless signals using beams (e.g., Tx beams and Rx beams). Beam formation may be performed using digital and/or analog beam formation techniques, with respective digital and/or analog circuitry. The wireless communication interface 530 may include such circuitry.

Depending on desired functionality, the wireless communication interface 530 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 500 may communicate with different data networks that may comprise various network types. For example, one such network type may comprise a wireless wide area network (WWAN), which may be a code-division multiple access (CDMA) network, a time division multiple access (TDMA) network, a frequency division multiple access (FDMA) network, an orthogonal frequency division multiple access (OFDMA) network, a single-carrier frequency division multiple access (SC-FDMA) network, a WiMAX (IEEE 802.16) network, and so on. A CDMA network may implement one or more radio access technologies (RATs) such as CDMA2000®, wideband code division multiple access (WCDMA), and so on. CDMA2000® includes IS-95, IS-2000 and/or IS-856 standards. A TDMA network may implement global system for mobile communications (GSM), digital advanced mobile phone system (D-AMPS), or some other RAT. An OFDMA network may employ long-term evolution (LTE), LTE Advanced, fifth-generation (5G) new radio (NR), and so on. 5G NR, LTE, LTE Advanced, GSM, and WCDMA are described in documents from 3rd Generation Partnership Project (3GPP). CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 500 can further include sensor(s) 540. Sensor(s) 540 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 500 may also include a Global Navigation Satellite System (GNSS) receiver 580 capable of receiving signals 584 from one or more GNSS satellites using an antenna 582 (which could be the same as antenna 532). Positioning based on GNSS signal measurement can be utilized to complement and/or incorporate the techniques described herein. The GNSS receiver 580 can extract a position of the UE 500, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 580 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 580 is illustrated in FIG. 5 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 510, DSP 520, and/or a processor within the wireless communication interface 530 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 510 or DSP 520.

The UE 500 may further include and/or be in communication with a memory 560. The memory 560 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 560 of the UE 500 also can comprise software elements (not shown in FIG. 5), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 560 that are executable by the UE 500 (and/or processor(s) 510 or DSP 520 within UE 500). In some embodiments, then, such code and/or instructions can be used to configure and/or adapt a general-purpose computer (or other device) to perform one or more operations in accordance with the described methods.

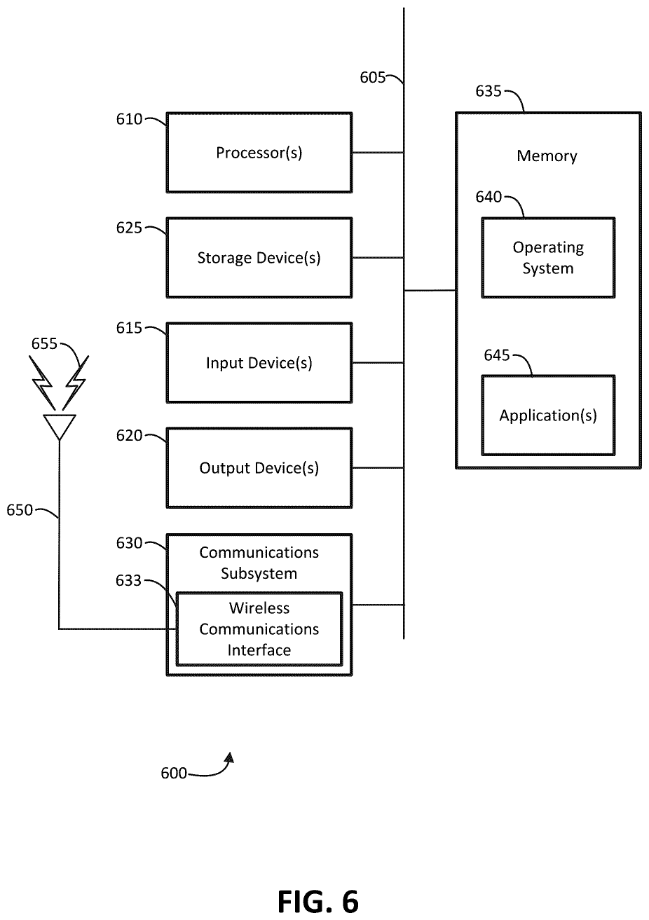

FIG. 6 is a block diagram of an embodiment of a computer system 600 (e.g., a P-CSCF, E-CSCF, LRF or PSAP), which may be used, in whole or in part, to provide the functions of one or more components, servers, and/or devices as described in the embodiments herein. This may include, for example, a computer server, personal computer, personal electronic device, or the like. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner. In addition, it can be noted that components illustrated by FIG. 6 can be localized to a single device and/or distributed among various networked devices, which may be disposed at different geographical locations.

The computer system 600 is shown comprising hardware elements that can be electrically coupled via a bus 605 (or may otherwise be in communication, as appropriate). The hardware elements may include processor(s) 610, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 600 also may comprise one or more input devices 615, which may comprise without limitation a mouse, a keyboard, a camera, a microphone, and/or the like; and one or more output devices 620, which may comprise without limitation a display device, a printer, and/or the like.

The computer system 600 may further include (and/or be in communication with) one or more non-transitory storage devices 625, which can comprise, without limitation, local and/or network accessible storage, and/or may comprise, without limitation, a disk drive, a drive array, an optical storage device, a solid-state storage device, such as a random-access memory (RAM) and/or read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 600 may also include a communications subsystem 630, which may comprise wireless communication technologies managed and controlled by a wireless communication interface 633, as well as wired technologies (such as Ethernet, coaxial communications, universal serial bus (USB), and the like). The wireless communication interface 633 may comprise one or more wireless transceivers that may send and receive wireless signals 655 (e.g., signals according to 5G NR or LTE) via wireless antenna(s) 650. Thus the communications subsystem 630 may comprise a modem, a network card (wireless or wired), an infrared communication device, a wireless communication device, and/or a chipset, and/or the like, which may enable the computer system 600 to communicate on any or all of the communication networks described herein to any device on the respective network, including a User Equipment (UE), base stations and/or other transmission reception points (TRPs), and/or any other electronic devices described herein. Hence, the communications subsystem 630 may be used to receive and send data as described in the embodiments herein.

In many embodiments, the computer system 600 will further comprise a working memory 635, which may comprise a RAM or ROM device, as described above. Software elements, shown as being located within the working memory 635, may comprise an operating system 640, device drivers, executable libraries, and/or other code, such as one or more applications 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 625 described above. In some cases, the storage medium might be incorporated within a computer system, such as computer system 600. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

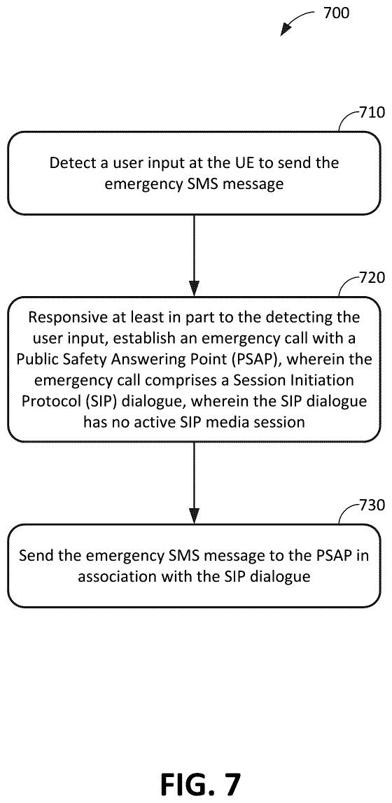

FIG. 7 is a flow diagram of a method 700 performed at a UE of sending an emergency SMS message, according to an embodiment. The method 700 may be performed by a UE 105 as described herein (e.g., with respect to FIGS. 1-6). Specifically, aspects of the method 700 may reflect functionality of a UE described above with respect to FIGS. 3-4. Means and/or structure for performing the operations of the method 700 may comprise hardware and/or software components of a UE, such as the components of UE 500 illustrated in FIG. 5, described above.

At block 710, the functionality comprises detecting a user input at the UE to send the emergency SMS message. This functionality may correspond to, for example, the functionality at stage 2 of FIGS. 3 and/or 4. As noted in the embodiments herein, additional functions may be responsive at least in part to detecting the user input and performed prior to establishing an emergency call (e.g., at block 720, discussed below). For example, alternative embodiments of the method 700 may further comprise performing an attach or an emergency attach with a fourth-generation (4G) cellular network, wherein performing the attach or emergency attach is responsive at least in part to the detecting the user input, and performed prior to establishing the emergency call. Such embodiments may further comprise establishing an emergency Packet Data Network (PDN) connection prior to establishing the emergency call. Some embodiments may comprise performing a registration or an emergency registration with a fifth-generation (5G) cellular network, wherein performing the registration or the emergency registration is responsive at least in part to the detecting the user input, and performed prior to establishing the emergency call. Such embodiments may further comprise establishing an emergency Packet Data Unit (PDU) session prior to establishing the emergency call.

Means and/or structure for performing the functionality of block 710 may comprise various hardware and/or software components of the UE 500 of FIG. 5. This may include, for example, bus 505, one or more processors 510, a wireless communication interface 530 (including one or more transceivers), one or more sensors 540, one or more memories 560, one or more input devices 570, one or more GNSS receivers 580, and/or other components of a UE 500. Details regarding these and other components of the UE 500 are provided in the description of FIG. 5 above.

At block 720, the functionality comprises, responsive at least in part to the detecting the user input, establishing an emergency call with a Public Safety Answering Point (PSAP), wherein the emergency call comprises a Session Initiation Protocol (SIP) dialogue, wherein the SIP dialogue has no active SIP media session. This may correspond, for example, with stage 6 of FIGS. 3 and/or 4. According to some embodiments, the SIP dialogue may be established using an Internet Protocol (IP) Multimedia Subsystem (IMS). Such embodiments may further comprise performing an IMS Emergency Registration (e.g., as illustrated at stage 5 of FIGS. 3 and/or 4).

Means and/or structure for performing the functionality of block 720 may comprise various hardware and/or software components of the UE 500 of FIG. 5. This may include, for example, bus 505, one or more processors 510, a wireless communication interface 530 (including one or more transceivers), one or more memories 560, and/or other components of a UE 500. Details regarding these and other components of the UE 500 are provided in the description of FIG. 5 above.

At block 730, the functionality comprises sending the emergency SMS message to the PSAP in association with the SIP dialogue. This functionality may correspond with, for example, stage 7 of FIG. 3 and stages 6a and 6b of FIG. 4.

Means and/or structure for performing the functionality of block 730 may comprise various hardware and/or software components of the UE 500 of FIG. 5. This may include, for example, bus 505, one or more processors 510, a wireless communication interface 530 (including one or more transceivers), one or more memories 560, and/or other components of a UE 500. Details regarding these and other components of the UE 500 are provided in the description of FIG. 5 above.

As noted in the embodiments described above, embodiments may include other features and/or functions. For example, according to some embodiments, the emergency SMS message is sent in an SIP MESSAGE. Such embodiments may further comprise receiving a SIP 200 OK or SIP 202 in association with the SIP dialogue, the SIP 200 OK or SIP 202 acknowledging receipt of the emergency SMS MESSAGE by the PSAP or by an ESInet.

Alternative embodiments of the method 700 may include one or more additional features, depending on desired functionality. For example, according to some embodiments, establishing the emergency call with the PSAP may comprise sending a SIP INVITE to the PSAP, wherein the SIP INVITE indicates no active SIP media session; and receiving a SIP 200 OK from the PSAP, wherein the SIP 200 OK indicates no active SIP media session. The SIP INVITE may not include a Session Description Protocol (SDP) description for SIP media, and the SIP 200 OK may not include an SDP description for SIP media, e.g. as for alternative ALT1 described above. In some embodiments, the SIP INVITE and the SIP 200 OK may each include a Session Description Protocol (SDP) description for SIP media, wherein the SDP description for SIP media in the SIP INVITE and in the SIP 200 OK may include an indication of inactive media, e.g. as for alternative ALT2 described above. The SIP INVITE and the SIP 200 OK may each include a Session Description Protocol (SDP) description for SIP media, and the SDP description for SIP media in the SIP INVITE and in the SIP 200 OK may include an indication that no media sessions are to be established between the UE and PSAP, e.g. as for alternative ALT3 described above. In some embodiments, the indication that no media sessions are to be established between the UE and PSAP may comprise an inclusion of zero media text lines in the SDP description in the SIP INVITE and the SIP 200 OK, wherein a media text line includes an “m=” character sequence. According to some embodiments, the emergency SMS message may be included in the SIP INVITE. Additionally, or alternatively, the SIP 200 OK may include an emergency SMS message response from the PSAP. According to some embodiments, the method 700 may further comprise sending a location of the UE to the PSAP in the SIP INVITE or in a SIP UPDATE.

Alternative embodiments of the method 700 may further comprise receiving an SMS message from the PSAP in a SIP MESSAGE, sending an SMS message to the PSAP in an SIP MESSAGE, or both, subsequent to sending the emergency SMS message to the PSAP.

Some embodiments may further comprise establishing a voice media session for the SIP dialogue between the UE and the PSAP, subsequent to sending the emergency SMS message to the PSAP. In some embodiments, the emergency call may be released by the UE following a timeout after a last SMS message is received or sent by the UE.

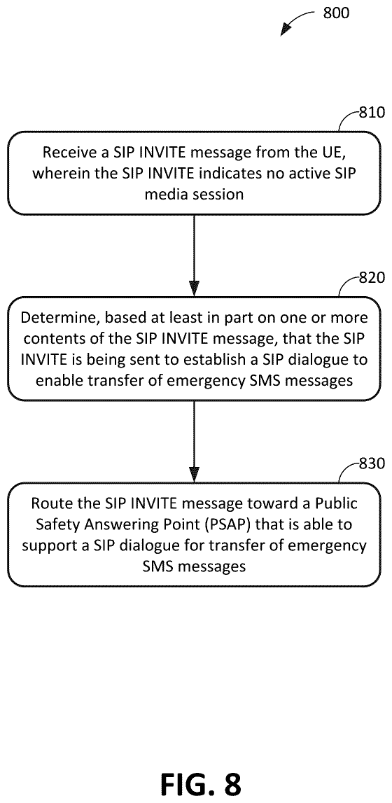

FIG. 8 is a flow diagram of a method 800 performed at a server for supporting the sending of an emergency SMS message by a UE, according to an embodiment. The method 800 may be performed by a server as described herein (e.g., with respect to FIGS. 1-6). Specifically, aspects of the method 800 may reflect functionality described above with respect to an IMS of FIGS. 2-4. Means and/or structure for performing the operations of the method 800 may comprise hardware and/or software components of a computer system, such as the components of computer system 600 illustrated in FIG. 6, described above.

At block 810, the functionality comprises receiving a SIP INVITE message from the UE, wherein the SIP INVITE indicates no active SIP media session. This functionality may correspond to, for example, the functionality at stage 6a of FIGS. 3 and/or 4.

Means and/or structure for performing the particular functionality of block 810 may comprise various hardware and/or software components of the computer system 600 of FIG. 6. This may include, for example, bus 605, one or more processors 610, communications subsystem 630 (including one or more transceivers), one or more memories 635 (including one or more operating systems 640 and/or one or more applications 645), and/or other components of a computer system 600. Details regarding these and other components of the computer system 600 are provided in the description of FIG. 6 above.

At block 820, the functionality comprises, determining, based at least in part on one or more contents of the SIP INVITE message, that the SIP INVITE is being sent to establish a SIP dialogue to enable transfer of emergency SMS messages. As noted in herein, according to some embodiments, the one or more contents of the SIP INVITE message may comprise an emergency number or SOS URN, a SIP header indicating a SIP dialogue to enable transfer of SMS messages, an indication that the UE is able to receive and send SMS messages, an SMS message, an indication that an active SIP media session will not be established, or any combination thereof.

Means and/or structure for performing the particular functionality of block 820 may comprise various hardware and/or software components of the computer system 600 of FIG. 6. This may include, for example, bus 605, one or more processors 610, one or more memories 635 (including one or more operating systems 640 and/or one or more applications 645), and/or other components of a computer system 600. Details regarding these and other components of the computer system 600 are provided in the description of FIG. 6 above.

At block 830, the functionality comprises routing the SIP INVITE message toward a Public Safety Answering Point (PSAP) that is able to support a SIP dialogue for transfer of emergency SMS messages. This functionality may correspond with, for example, stage 6b of FIGS. 3 and 4. According to some embodiments, routing the SIP INVITE message toward the PSAP is based at least in part on a routing address of the PSAP configured in the server.

Means and/or structure for performing the particular functionality of block 830 may comprise various hardware and/or software components of the computer system 600 of FIG. 6. This may include, for example, bus 605, one or more processors 610, communications subsystem 630 (including one or more transceivers), one or more memories 635 (including one or more operating systems 640 and/or one or more applications 645), and/or other components of a computer system 600. Details regarding these and other components of the computer system 600 are provided in the description of FIG. 6 above.

As noted in the embodiments described above, embodiments may include other features and/or functions. For example, according to some embodiments, the server may comprise an Emergency Call Session Control Function (e.g. E-CSCF 230) or a Location Retrieval Function (e.g. LRF 290). In addition or instead, the server may be part of an IP Multimedia Subsystem (e.g. IMS 280) in a serving Public Land Mobile Network (e.g. serving network 140) for the UE.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method performed at a User Equipment (UE) of sending an emergency Short Message Service (SMS) message, the method comprising: detecting a user input at the UE to send the emergency SMS message; responsive at least in part to the detecting the user input, establishing an emergency call with a Public Safety Answering Point (PSAP), wherein the emergency call comprises a Session Initiation Protocol (SIP) dialogue, wherein the SIP dialogue has no active SIP media session; and sending the emergency SMS message to the PSAP in association with the SIP dialogue.

Clause 2: The method of clause 1, wherein the SIP dialogue is established using an Internet Protocol (IP) Multimedia Subsystem (IMS).

Clause 3: The method of either of clause 2, further comprising performing an IMS Emergency Registration.

Clause 4: The method of any one of clauses 1-3, further comprising performing an attach or an emergency attach with a fourth-generation (4G) cellular network, wherein performing the attach or emergency attach is: responsive at least in part to the detecting the user input, and performed prior to establishing the emergency call.

Clause 5: The method of clause 4, further comprising establishing an emergency Packet Data Network (PDN) connection prior to establishing the emergency call.

Clause 6: The method of any one of clauses 1-5, further comprising performing a registration or an emergency registration with a fifth-generation (5G) cellular network, wherein performing the registration or the emergency registration is: responsive at least in part to the detecting the user input, and performed prior to establishing the emergency call.

Clause 7: The method of clause 6, further comprising establishing an emergency Packet Data Unit (PDU) session prior to establishing the emergency call.

Clause 8: The method of any one of clauses 1-7, wherein the emergency SMS message is sent in a SIP MESSAGE.

Clause 9: The method of any one of clauses 1-8, further comprising receiving a SIP 200 OK or SIP 202 in association with the SIP dialogue, the SIP 200 OK or SIP 202 acknowledging receipt of the emergency SMS MESSAGE by the PSAP or by an Emergency Services IP network (ESInet).

Clause 10: The method of any one of clauses 1-9, wherein establishing the emergency call with the PSAP comprises: sending a SIP INVITE to the PSAP, wherein the SIP INVITE indicates no active SIP media session; and receiving a SIP 200 OK from the PSAP, wherein the SIP 200 OK indicates no active SIP media session.

Clause 11: The method of clause 10, wherein the SIP INVITE does not include a Session Description Protocol (SDP) description for SIP media, wherein SIP 200 OK does not include an SDP description for SIP media.

Clause 12: The method of clause 10, wherein the SIP INVITE and the SIP 200 OK include a Session Description Protocol (SDP) description for SIP media, wherein the SDP description for SIP media in the SIP INVITE and in the SIP 200 OK includes an indication of inactive media.

Clause 13: The method of clause 10, wherein the SIP INVITE and the SIP 200 OK include a Session Description Protocol (SDP) description for SIP media, wherein the SDP description for SIP media in the SIP INVITE and the SIP 200 OK include an indication that no media sessions are to be established between the UE and PSAP.

Clause 14: The method of clause 13, wherein the indication that no media sessions are to be established between the UE and PSAP comprises an inclusion of zero media text lines in the SDP description in the SIP INVITE and the SIP 200 OK, wherein a media text line includes an m=character sequence.

Clause 15: The method of clause 10, wherein the emergency SMS message is included in the SIP INVITE.

Clause 16: The method of any one of clauses 1-15, wherein the SIP 200 OK includes an emergency SMS message response from the PSAP.

Clause 17: The method of any one of clauses 1-16, further comprising sending a location of the UE to the PSAP in the SIP INVITE or in a SIP UPDATE.

Clause 18: The method of any one of clauses 1-17, further comprising receiving an SMS message from the PSAP in a SIP MESSAGE, sending an SMS message to the PSAP in an SIP MESSAGE, or both, subsequent to sending the emergency SMS message to the PSAP.

Clause 19: The method of any one of clauses 1-18, further comprising establishing a voice media session for the SIP dialogue between the UE and the PSAP, subsequent to sending the emergency SMS message to the PSAP.

Clause 20: The method of any one of clauses 1-19, wherein the emergency call is released by the UE following a timeout after a last SMS message is received or sent by the UE.

Clause 21: A method at a server for supporting the sending of an emergency Short Message Service (SMS) message by a user equipment (UE), the method comprising: receiving a Session Initiation Protocol (SIP) INVITE message from the UE, wherein the SIP INVITE indicates no active SIP media session; determining, based at least in part on one or more contents of the SIP INVITE message, that the SIP INVITE is being sent to establish a SIP dialogue to enable transfer of emergency SMS messages; and routing the SIP INVITE message toward a Public Safety Answering Point (PSAP) that is able to support a SIP dialogue for transfer of emergency SMS messages.

Clause 22: The method of clause 21, wherein the one or more contents of the SIP INVITE message comprise an emergency number or SOS Uniform Resource Name (URN), a SIP header indicating a SIP dialogue to enable transfer of SMS messages, an indication that the UE is able to receive and send SMS messages, an SMS message, an indication that an active SIP media session will not be established, or any combination thereof.

Clause 23: The method of either of clauses 21 or 22, wherein the server comprises an Emergency Call Session Control Function (E-CSCF) or a Location Retrieval Function (LRF).

Clause 24: The method of any one of clauses 21-23, wherein the server is part of an IP Multimedia Subsystem (IMS) in a serving Public Land Mobile Network (PLMN) for the UE.

Clause 25: The method of any one of clauses 21-24, wherein routing the SIP INVITE message toward the PSAP is based at least in part on a routing address of the PSAP configured in the server.

Clause 26: A User Equipment (UE) comprising: at least one transceiver; at least one memory; and at least one processor communicatively coupled with the at least one transceiver and the at least one memory, the at least one processor configured to: detect a user input at the UE to send an emergency Short Message Service (SMS) message; responsive at least in part to the detecting the user input, establish an emergency call with a Public Safety Answering Point (PSAP) via the at least one transceiver, wherein the emergency call comprises a Session Initiation Protocol (SIP) dialogue, wherein the SIP dialogue has no active SIP media session; and send the emergency SMS message via the at least one transceiver to the PSAP in association with the SIP dialogue.

Clause 27: The UE of clause 26, wherein the at least one processor is configured to establish the SIP dialogue using an Internet Protocol (IP) Multimedia Subsystem (IMS).

Clause 28: The UE of clause 27, wherein the at least one processor is further configured to perform an IMS Emergency Registration.

Clause 29: The UE of any one of clauses 26-28, wherein the at least one processor is further configured to perform an attach or an emergency attach with a fourth-generation (4G) cellular network, wherein performing the attach or emergency attach is: responsive at least in part to the detecting the user input, and performed prior to establishing the emergency call.

Clause 30: The UE of clause 29, wherein the at least one processor is further configured to establish an emergency Packet Data Network (PDN) connection prior to establishing the emergency call.

Clause 31: The UE of any one of clauses 26-30, wherein the at least one processor is further configured to perform a registration or an emergency registration with a fifth-generation (5G) cellular network, wherein performing the registration or the emergency registration is: responsive at least in part to the detecting the user input, and performed prior to establishing the emergency call.

Clause 32: The UE of clause 31, wherein the at least one processor is further configured to establish an emergency Packet Data Unit (PDU) session prior to establishing the emergency call.

Clause 33: The UE of any one of clauses 26-32, wherein the at least one processor is further configured to send the emergency SMS message in a SIP MESSAGE.

Clause 34: The UE of any one of clauses 26-33, wherein the at least one processor is further configured to receive, in association with the SIP dialogue, a SIP 200 OK or SIP 202 that acknowledges receipt of the emergency SMS MESSAGE by the PSAP or by an Emergency Services IP network (ESInet).

Clause 35: The UE of any one of clauses 26-34, wherein to establish the emergency call with the PSAP, the at least one processor is configured to: send, to the PSAP via the at least one transceiver, a SIP INVITE that indicates no active SIP media session; and receive, from the PSAP via the at least one transceiver, a SIP 200 OK that indicates no active SIP media session.

Clause 36: The UE of any one of clause 35, wherein the at least one processor is configured to send the SIP INVITE and receive the SIP 200 OK in which the SIP INVITE does not include a Session Description Protocol (SDP) description for SIP media, wherein SIP 200 OK does not include an SDP description for SIP media.

Clause 37: The UE of clause 35, wherein the at least one processor is configured to send the SIP INVITE and receive the SIP 200 OK in which the SIP INVITE and the SIP 200 OK include a Session Description Protocol (SDP) description for SIP media, and the SDP description for SIP media in the SIP INVITE and in the SIP 200 OK includes an indication of inactive media.

Clause 38: The UE of clause 35, wherein the at least one processor is configured to send the SIP INVITE and receive the SIP 200 OK in which the SIP INVITE and the SIP 200 OK include a Session Description Protocol (SDP) description for SIP media, and the SDP description for SIP media in the SIP INVITE and the SIP 200 OK include an indication that no media sessions are to be established between the UE and PSAP.

Clause 39: The UE of clause 38, wherein the at least one processor is configured to send the SIP INVITE and receive the SIP 200 OK in which the indication that no media sessions are to be established between the UE and PSAP comprises an inclusion of zero media text lines in the SDP description in the SIP INVITE and the SIP 200 OK, wherein a media text line includes an m=character sequence.

Clause 40: The UE of clause 35, wherein the at least one processor is configured to include the emergency SMS message in the SIP INVITE.

Clause 41: The UE of any one of clauses 26-40, wherein the at least one processor is configured to receive the SIP 200 OK in which the SIP 200 OK includes an emergency SMS message response from the PSAP.

Clause 42: The UE of any one of clauses 26-41, further comprising sending a location of the UE to the PSAP in the SIP INVITE or in a SIP UPDATE.

Clause 43: The UE of any one of clauses 26-42, wherein the at least one processor is further configured to receive an SMS message via the at least one transceiver from the PSAP in a SIP MESSAGE, send an SMS message via the at least one transceiver to the PSAP in an SIP MESSAGE, or both, subsequent to sending the emergency SMS message to the PSAP.

Clause 44: The UE of any one of clauses 26-43, wherein the at least one processor is further configured to establish a voice media session for the SIP dialogue between the UE and the PSAP, subsequent to sending the emergency SMS message to the PSAP.

Clause 45: The UE of any one of clauses 26-44, wherein the at least one processor is further configured to release the emergency call following a timeout after a last SMS message is received or sent by the UE.

Clause 46: A server comprising: at least one transceiver; at least one memory; and at least one processor communicatively coupled with the at least one transceiver and the at least one memory, the at least one processor configured to: receive a Session Initiation Protocol (SIP) INVITE message via the at least one transceiver from a user equipment (UE), wherein the SIP INVITE indicates no active SIP media session; determine, based at least in part on one or more contents of the SIP INVITE message, that the SIP INVITE is being sent to establish a SIP dialogue to enable transfer of emergency Short Message Service (SMS) messages; and route the SIP INVITE message toward a Public Safety Answering Point (PSAP) that is able to support a SIP dialogue for transfer of emergency SMS messages.

Clause 47: The server of clause 46, wherein to receive the SIP INVITE message, the at least one processor is configured to receive one or more contents of the SIP INVITE message comprising an emergency number or SOS Uniform Resource Name (URN), a SIP header indicating a SIP dialogue to enable transfer of SMS messages, an indication that the UE is able to receive and send SMS messages, an SMS message, an indication that an active SIP media session will not be established, or any combination thereof.

Clause 48: The server of either of clauses 46 or 47, wherein the server comprises an Emergency Call Session Control Function (E-CSCF) or a Location Retrieval Function (LRF).

Clause 49: The server of any one of clauses 46-48, wherein the server is part of an IP Multimedia Subsystem (IMS) in a serving Public Land Mobile Network (PLMN) for the UE.

Clause 50: The server of any one of clauses 46-49, wherein the at least one processor is configured to route the SIP INVITE message toward the PSAP based at least in part on a routing address of the PSAP configured in the server.

Clause 51. An apparatus having means for performing the method of any one of clauses 1-25.

Clause 52. A non-transitory computer-readable medium storing instructions, the instructions comprising code for performing the method of any one of clauses 1-25.

Clause 53. At least one PSAP server having one or more transceivers, one or more memories, and one or more processors communicatively coupled with the one or more transceivers and the one or more memories, the one or more processors configured to cause the least one PSAP server to interact with a UE to enable the UE to perform the method of any one of clauses 1-25.

What is claimed is:

1. A method performed at a User Equipment (UE) of sending an emergency Short Message Service (SMS) message, the method comprising:
detecting a user input at the UE to send the emergency SMS message;
responsive at least in part to the detecting the user input, establishing an emergency call with a Public Safety Answering Point (PSAP), wherein the emergency call comprises a Session Initiation Protocol (SIP) dialogue, wherein the SIP dialogue has no active SIP media session; and
sending the emergency SMS message to the PSAP in association with the SIP dialogue.

2. The method of claim 1, wherein the SIP dialogue is established using an Internet Protocol (IP) Multimedia Subsystem (IMS).

3. The method of claim 1, further comprising performing an attach or an emergency attach with a fourth-generation (4G) cellular network, wherein performing the attach or emergency attach is:
responsive at least in part to the detecting the user input, and
performed prior to establishing the emergency call.

4. The method of claim 1, further comprising performing a registration or an emergency registration with a fifth-generation (5G) cellular network, wherein performing the registration or the emergency registration is:
responsive at least in part to the detecting the user input, and
performed prior to establishing the emergency call.

5. The method of claim 1, wherein the emergency SMS message is sent in a SIP MESSAGE.

6. The method of claim 1, wherein establishing the emergency call with the PSAP comprises:
sending a SIP INVITE to the PSAP, wherein the SIP INVITE indicates no active SIP media session; and
receiving a SIP 200 OK from the PSAP, wherein the SIP 200 OK indicates no active SIP media session.

7. The method of claim 6, wherein the SIP INVITE does not include a Session Description Protocol (SDP) description for SIP media, wherein SIP 200 OK does not include an SDP description for SIP media.

8. The method of claim 6, wherein the SIP INVITE and the SIP 200 OK include a Session Description Protocol (SDP) description for SIP media, and wherein: either (1) the SDP description for SIP media in the SIP INVITE and in the SIP 200 OK includes an indication of inactive media, or (2) the SDP description for SIP media in the SIP INVITE and in the SIP 200 OK includes an indication that no media sessions are to be established between the UE and PSAP.

9. The method of claim 1, further comprising receiving an SMS message from the PSAP in a SIP MESSAGE, sending an SMS message to the PSAP in an SIP MESSAGE, or both, subsequent to sending the emergency SMS message to the PSAP.

10. The method of claim 1, further comprising establishing a voice media session for the SIP dialogue between the UE and the PSAP, subsequent to sending the emergency SMS message to the PSAP.

11. A method at a server for supporting the sending of an emergency Short Message Service (SMS) message by a user equipment (UE), the method comprising:
receiving a Session Initiation Protocol (SIP) INVITE message from the UE, wherein the SIP INVITE indicates no active SIP media session;
determining, based at least in part on one or more contents of the SIP INVITE message, that the SIP INVITE is being sent to establish a SIP dialogue to enable transfer of emergency SMS messages; and
routing the SIP INVITE message toward a Public Safety Answering Point (PSAP) that is able to support a SIP dialogue for transfer of emergency SMS messages.

12. The method of claim 11, wherein the one or more contents of the SIP INVITE message comprise an emergency number or SOS Uniform Resource Name (URN), a SIP header indicating a SIP dialogue to enable transfer of SMS messages, an indication that the UE is able to receive and send SMS messages, an SMS message, an indication that an active SIP media session will not be established, or any combination thereof.

13. The method of claim 11, wherein the server comprises an Emergency Call Session Control Function (E-CSCF) or a Location Retrieval Function (LRF).

14. The method of claim 11, wherein routing the SIP INVITE message toward the PSAP is based at least in part on a routing address of the PSAP configured in the server.

15. A User Equipment (UE) comprising:
at least one transceiver;
at least one memory; and
at least one processor communicatively coupled with the at least one transceiver and the at least one memory, the at least one processor configured to:
detect a user input at the UE to send an emergency Short Message Service (SMS) message;
responsive at least in part to the detecting the user input, establish an emergency call with a Public Safety Answering Point (PSAP) via the at least one transceiver, wherein the emergency call comprises a Session Initiation Protocol (SIP) dialogue, wherein the SIP dialogue has no active SIP media session; and
send the emergency SMS message via the at least one transceiver to the PSAP in association with the SIP dialogue.

16. The UE of claim 15, wherein the at least one processor is configured to establish the SIP dialogue using an Internet Protocol (IP) Multimedia Subsystem (IMS).

17. The UE of claim 15, wherein the at least one processor is further configured to perform an attach or an emergency attach with a fourth-generation (4G) cellular network, wherein performing the attach or emergency attach is:
responsive at least in part to the detecting the user input, and
performed prior to establishing the emergency call.

18. The UE of claim 15, wherein the at least one processor is further configured to perform a registration or an emergency registration with a fifth-generation (5G) cellular network, wherein performing the registration or the emergency registration is:
responsive at least in part to the detecting the user input, and
performed prior to establishing the emergency call.

19. The UE of claim 15, wherein the at least one processor is further configured to send the emergency SMS message in a SIP MESSAGE.

20. The UE of claim 15, wherein to establish the emergency call with the PSAP, the at least one processor is configured to:
send, to the PSAP via the at least one transceiver, a SIP INVITE that indicates no active SIP media session; and
receive, from the PSAP via the at least one transceiver, a SIP 200 OK that indicates no active SIP media session.

21. The UE of claim 20, wherein the at least one processor is configured to send the SIP INVITE and receive the SIP 200 OK in which the SIP INVITE does not include a Session Description Protocol (SDP) description for SIP media, wherein SIP 200 OK does not include an SDP description for SIP media.

22. The UE of claim 20, wherein the at least one processor is configured to send the SIP INVITE and receive the SIP 200 OK in which the SIP INVITE and the SIP 200 OK include a Session Description Protocol (SDP) description for SIP media, and either (1) the SDP description for SIP media in the SIP INVITE and in the SIP 200 OK includes an indication of inactive media, or (2) the SDP description for SIP media in the SIP INVITE and in the SIP 200 OK includes an indication that no media sessions are to be established between the UE and PSAP.

23. The UE of claim 15, wherein the at least one processor is further configured to receive an SMS message via the at least one transceiver from the PSAP in a SIP MESSAGE, send an SMS message via the at least one transceiver to the PSAP in an SIP MESSAGE, or both, subsequent to sending the emergency SMS message to the PSAP.

24. The UE of claim 15, wherein the at least one processor is further configured to establish a voice media session for the SIP dialogue between the UE and the PSAP, subsequent to sending the emergency SMS message to the PSAP.

25. The UE of claim 15, wherein the at least one processor is further configured to release the emergency call following a timeout after a last SMS message is received or sent by the UE.

26. A server comprising:
at least one transceiver;
at least one memory; and
at least one processor communicatively coupled with the at least one transceiver and the at least one memory, the at least one processor configured to:
receive a Session Initiation Protocol (SIP) INVITE message via the at least one transceiver from a user equipment (UE), wherein the SIP INVITE indicates no active SIP media session;
determine, based at least in part on one or more contents of the SIP INVITE message, that the SIP INVITE is being sent to establish a SIP dialogue to enable transfer of emergency Short Message Service (SMS) messages; and
route the SIP INVITE message toward a Public Safety Answering Point (PSAP) that is able to support a SIP dialogue for transfer of emergency SMS messages.

27. The server of claim 26, wherein to receive the SIP INVITE message, the at least one processor is configured to receive one or more contents of the SIP INVITE message comprising an emergency number or SOS Uniform Resource Name (URN), a SIP header indicating a SIP dialogue to enable transfer of SMS messages, an indication that the UE is able to receive and send SMS messages, an SMS message, an indication that an active SIP media session will not be established, or any combination thereof.

28. The server of claim 26, wherein the server comprises an Emergency Call Session Control Function (E-CSCF) or a Location Retrieval Function (LRF).

29. The server of claim 26, wherein the server is part of an IP Multimedia Subsystem (IMS) in a serving Public Land Mobile Network (PLMN) for the UE.

30. The server of claim 26, wherein the at least one processor is configured to route the SIP INVITE message toward the PSAP based at least in part on a routing address of the PSAP configured in the server.
